(19) United States
(12) Patent Application Publication
(10) Pub. No.: US 2012/0050060 A1
(43) Pub. Date: Mar. 1, 2012

(54) FUNCTIONAL CONTROL ADAPTER FOR LIGHT GENERATING DEVICE

(76) Inventors: Wen-Yung Liao, Shulin City (TW); Wen-Fu Liao, Shulin City (TW); Sheng-Hsin Liao, Shulin City (TW)

(21) Appl. No.: 12/873,474

(22) Filed: Sep. 1, 2010

(51) Int. Cl. G08B 5/00; H01R 13/66

(52) U.S. Cl. 340/815.4; 439/620.02

(57) ABSTRACT

A functional control adapter for light generating devices includes a female portion, a male portion, and a control module. The female portion has an inlet body. The inlet body has a housing member having a first contact module. The male portion has an outlet body connected to the inlet body. A second contact module is disposed on the exterior of the outlet body. The control module is located at the inlet body and connected electrically to the first contact module of the female portion and the second contact module of the male portion. The adapter and the light source are joined separately, thus the lighting device can be dismounted or installed with convenience, and individual parts can be replaced as needed for reducing repair cost.

### BACKGROUND OF THE INVENTION

1. Field of the Invention

The present invention relates to a functional control adapter for light generating device; in particular, an adapter connecting the light socket and the light source with improved cost-effectiveness and adaptability.

2. Description of the Related Art

At home and public places, lighting is considered a practical necessity. To meet different demands, lighting exhibits various styles and functions. For example, a control module can be utilized to offer energy-saving, motion-sensing, light variation, or remote control capabilities.

Every light source and control module has a definite service life. If the control module is placed inside a lighting fixture, when the light source or the control module burns out, the whole lighting fixture must be replaced. Such method is not cost-effective. By setting the control module externally, the light source and the control module can be replaced separately. However, most external control modules are wired above the ceiling, which makes difficult to replace the device.

Based on research, the inventor proposes the present invention to address the above issues.

### SUMMARY OF THE INVENTION

The object of the instant disclosure is to provide a functional control adapter for light generating device. Especially, the adapter can be replaced separately with convenience, which saves maintenance cost and reduce unnecessary waste.

The other object of the instant disclosure is to provide an adapter that includes an alarm indicator.

The lighting adapter of the instant disclosure comprises a female portion having an inlet body with a housing member, which has an opening, and a first contact module disposed on the inlet body; a male portion having an outlet body connecting to the inlet body, with the outlet body having an external second contact module; and a control module located on the inlet body, wherein the control module is electrically connected to the first and second contact module.

The instant disclosure provides another lighting adapter, which comprises a female portion having an inlet body with a housing member, which has an opening, and a first contact module disposed on the inlet body; a male portion having a outlet body connecting to the inlet body, with the outlet body having an external second contact module; a control module located on the inlet body, wherein the control module is electrically connected to the first and second contact module; and at least one alarm indicator, which is located on the inlet body and electrically connected to the control module.

The instant disclosure offers the following advantages. The adapter and the light source are separate components. In other words, when the adapter's control module or the light source fails, each component can be replaced separately as needed in reducing repair cost and waste. In addition, the adapter, the light socket, and the light source can be easily disconnected from one another with convenience.

Furthermore, the adapter can have an alarm indicator. When the control module, light source, or the power supply fails, the alarm indicator will illuminate or buzz. The alarm notifies the user to inspect the light assembly for malfunction.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a schematic view of a lighting adapter according to a first embodiment of the instant disclosure.

FIG. 2 shows a schematic view of a lighting adapter according to a second embodiment of the instant disclosure.

FIG. 3 shows a schematic view of a lighting adapter according to a third embodiment of the instant disclosure.

FIG. 4 shows a schematic view of a lighting adapter according to a fourth embodiment of the instant disclosure.

FIG. 5 shows a schematic view of a lighting adapter according to a fifth embodiment of the instant disclosure.

FIG. 6 shows a schematic view of a lighting adapter according to a sixth embodiment of the instant disclosure.

FIG. 7 shows a schematic view of a lighting adapter according to a seventh embodiment of the instant disclosure.

FIG. 8 shows a schematic view of a lighting adapter according to an eighth embodiment of the instant disclosure.

FIG. 9 shows a schematic view of a lighting adapter according to a ninth embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

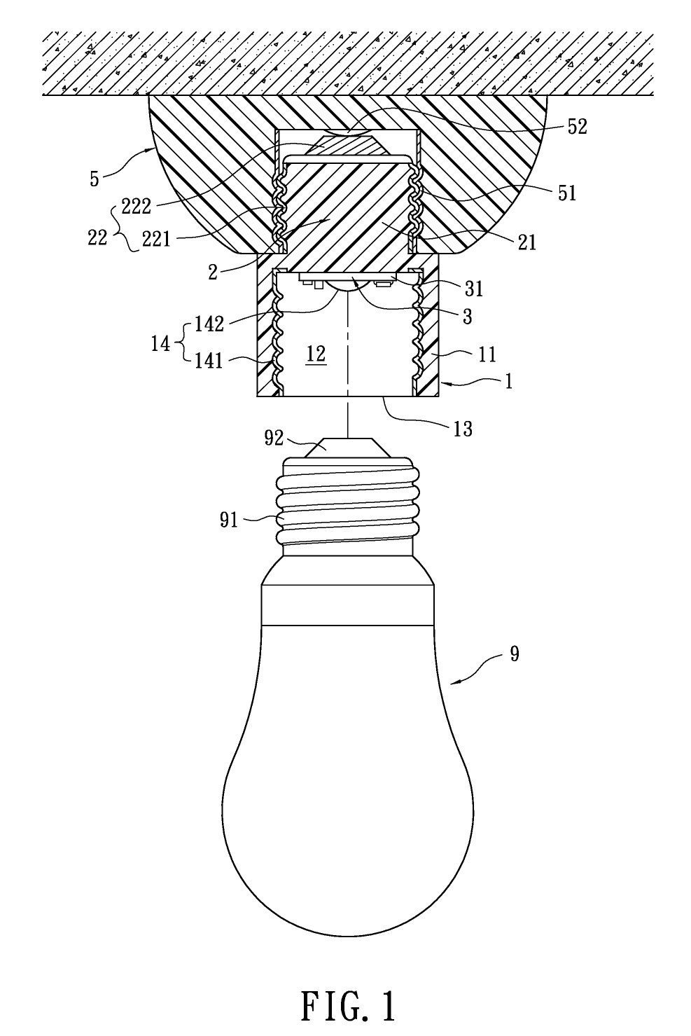

FIG. 1 shows the lighting adapter according to the first embodiment of the instant disclosure. The present embodiment applies to a light bulb type light source. The adapter includes a female portion 1, a male portion 2, and a control module 3. The female portion 1 has an inlet body 11 made of plastic material. The inlet body 11 has an opening 13 leading to a housing member 12. In the housing member 12, a first contact module 14 is located on the inner surface of the inlet body 11. The first contact module 14 includes a threaded collar 141 and a contact strip 142, with both made from metallic materials of high conductivity. The threaded collar 141 is fixed on the surface of the housing member 12, and the contact strip 142 is disposed at the bottom of the housing member. The contact strip 142 and the threaded collar 141 form the positive and negative contact points respectively. The female portion 1 of the present embodiment is designed for a light source 9 of light bulb type application. Depending on the type of light source 9, the female portion 1 can be modified accordingly.

The male portion 2 includes an outlet body 21 made of plastic material, and the outlet body 21 is formed integrally with the inlet body 11. A second contact module 22 is located at the exterior of the outlet body 21. The second contact module 22 includes a threaded collar 221 and a contact strip 222, with both made from metallic material of high conductivity. The threaded collar 221 is fixed at the exterior of the outlet body 21, and the contact strip 222 is located at the flat end of the outlet body 21. The contact strip 222 and the threaded collar 221 form the positive and negative contact points respectively. The male portion 2 of the present embodiment is designed for a light socket 5 of light bulb type application. Depending on the type of light socket 5, the male portion 2 can be modified accordingly.

The control module 3 is placed on the female portion 1. Specifically, the control module 3 is located at the inner surface of the inlet body 11. A person skill in the art should recognize that the structure or the function of the control module 3 should not be limited to the description of the instant embodiment. The control module 3 has a circuit board 31 consisted of desired electronic circuit and chip (not shown). The circuit board 31 can provide energy-saving, motion-sensing, light variation, or remote control functions by means of a switch, remote controller, light sensor, or voice activation. Through wiring and other conductive elements (not shown), the control module 3 is electrically connected to the threaded collar 141 and the contact strip 142 of the first contact module 14, along with the threaded collar 221 and the contact strip 222 of the second contact module 22.

The male portion 2 of the adapter can be connected to a conventional light socket 5. The threaded collar 221 and the contact strip 222 of the male portion 2 are electrically connected to the contact points 51, 52 of the light socket 5. Also, the light source 9 can be connected to the female portion 1 of the adapter. A screw cap 91 and an electrical contact 92 of the light source 9 are electrically connected to the corresponding threaded collar 141 and contact strip 142 of the female portion 1. Via the adapter, the power is passed onto the light source 9 for illumination.

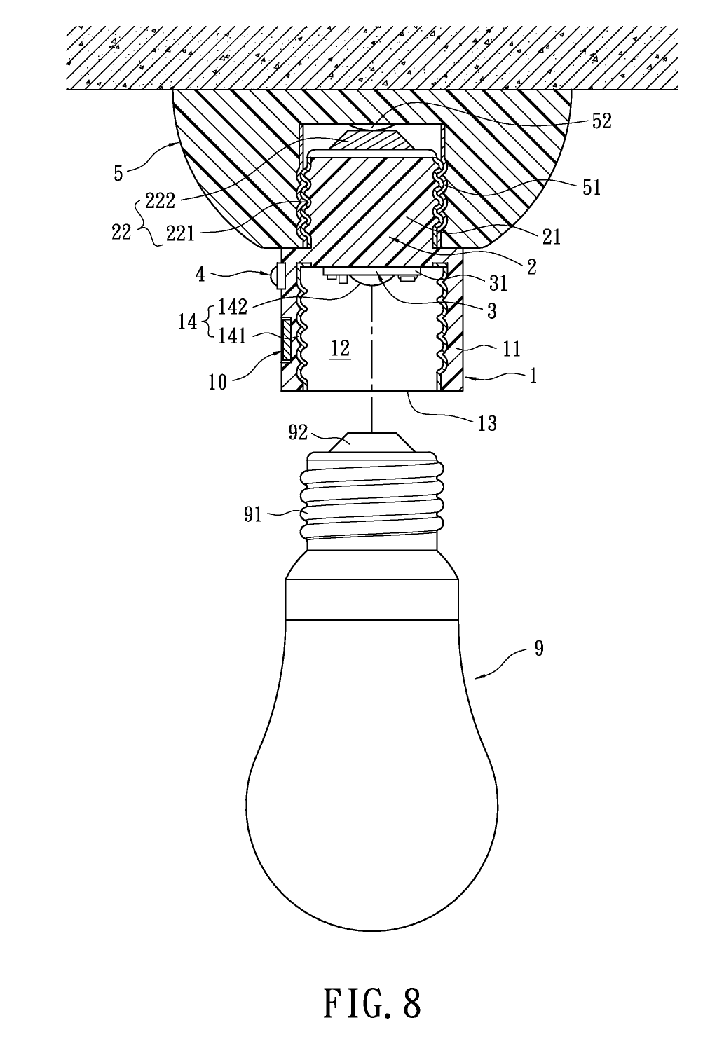

According to another embodiment, the adapter of the instant disclosure can include a replaceable battery 10 as shown in FIG. 8. The battery 10 is rechargeable and electrically connected to the control module 3. Therefore, during power failure, the battery 10 would provide power to the light source 9 for emergency service.

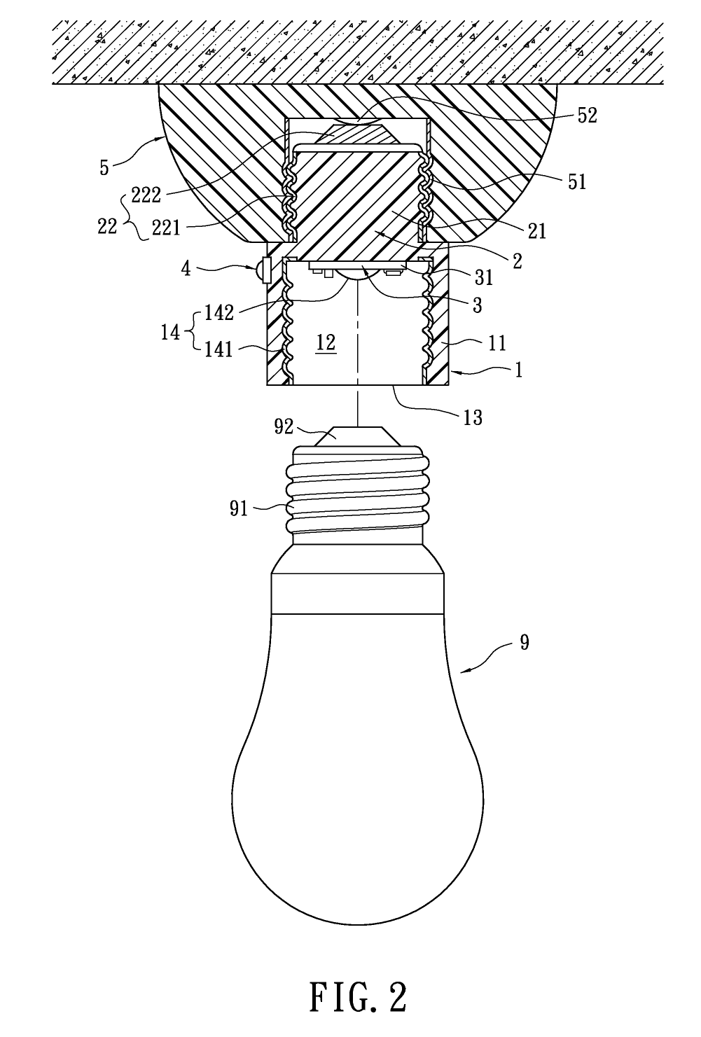

Please refer to FIG. 2, which shows the second embodiment of the instant disclosure. Particularly, an alarm indicator 4 is added onto the inlet body 11. The alarm indicator 4 can be a light indicator such as a LED or a sound device like a buzzer. By electrically connected to the control module 3, the alarm indicator 4 would illuminate or buzz if the control module 3, the light source 9, or the power supply fails.

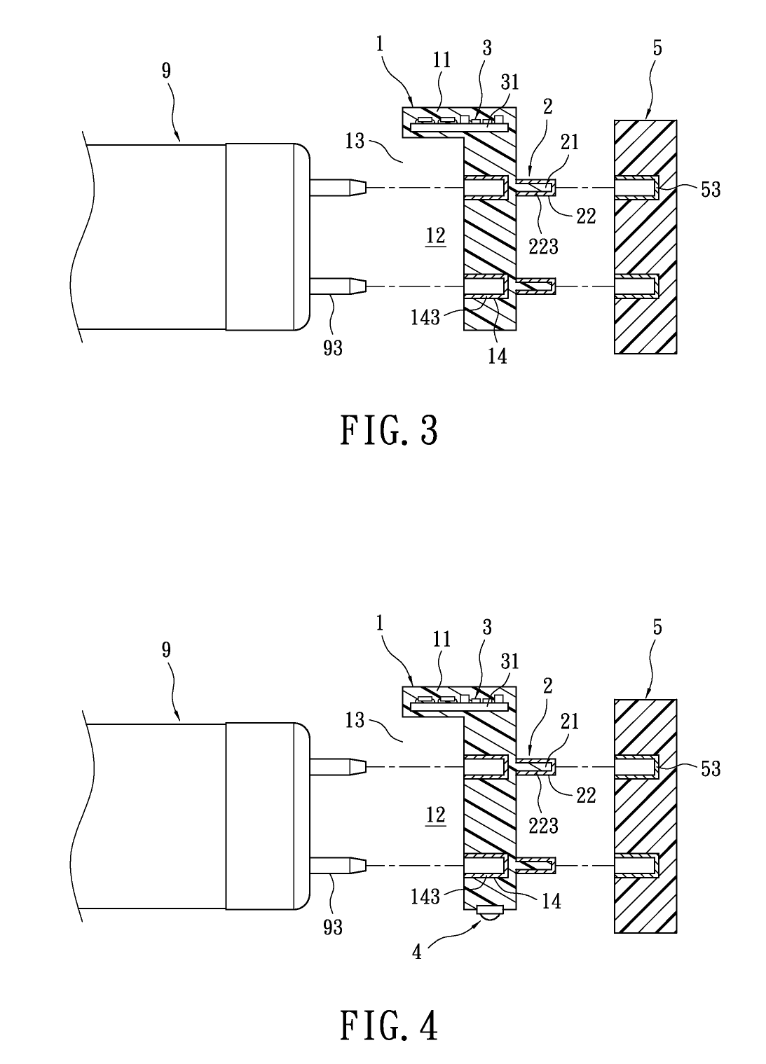

Please refer to FIGS. 3 and 4, which show the third and fourth embodiment of instant disclosure respectively. Both embodiments apply to a lamp tube type light source. The adapter includes a female portion 1, a male portion 2, and a control module 3. The female portion 1 and the male portion 2 are specifically designed for the lamp tube type light source 9 and light socket 5. The inlet body 11, or called an inlet portion, has a housing member 12 with an opening 13 to accommodate the light source 9. The inlet body 11 also includes a first contact module 14, which has two electric sockets 143 to accommodate two electric pins 93 of the light source 9. The outlet body 21, or called an outlet portion, of the male portion 2 has a second contact module 22 externally. The second contact module 22 has two electrodes 223.

Via the male portion 2, the adapter can connect to any conventional light socket 5. The electrodes 223 of the male portion 2 are electrically connected to the corresponding contact points 53 of the light socket 5. Similarly, the light source 9 connects to the female portion 1 of the adapter, where the electric pins 93 of the light source 9 are electrically connected to the electric sockets 143 of the female portion 1. Via the adapter, the power from the light socket 5 is passed onto the light source 9 for illumination.

According to another embodiment of the present disclosure, the control module 3 can also be disposed on the male portion 2. Namely, the control module 3 can be placed internally or externally of the outlet body 21 (not shown).

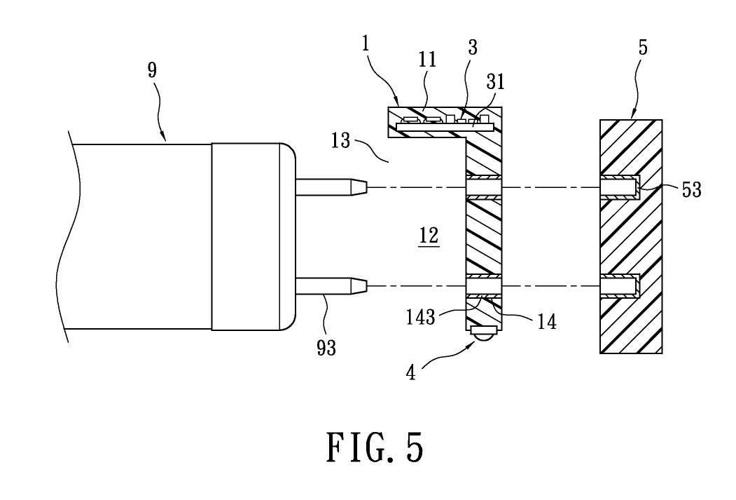

FIG. 5 shows another embodiment of the instant disclosure, which is applicable to the lamp tube type light source. The adapter includes only a female portion 1 and a control module 3. The inlet body 11 of the female portion 1 includes a first contact module 14. The first contact module 14 has two thru electric sockets 143 for accommodating the two electric pins 93 of the light source 9. Through wiring and other conductive elements (not shown), the control module 3 is electrically connected to the electric sockets 143 of the first contact module 14.

Via the female portion 1, the light source 9 is connected to the adapter, where the electric pins 93 of the light source 9 are connected electrically to the corresponding electric sockets 143 of the female portion 1. By penetrating the electric sockets 143 and the inlet body 11, the electric pins 93 of the light source 9 connects electrically to the corresponding contact points 53 of the light socket 5. Therefore, the light source 9 and the adapter are connected to the light socket 5, with the light socket 5 supplying the power.

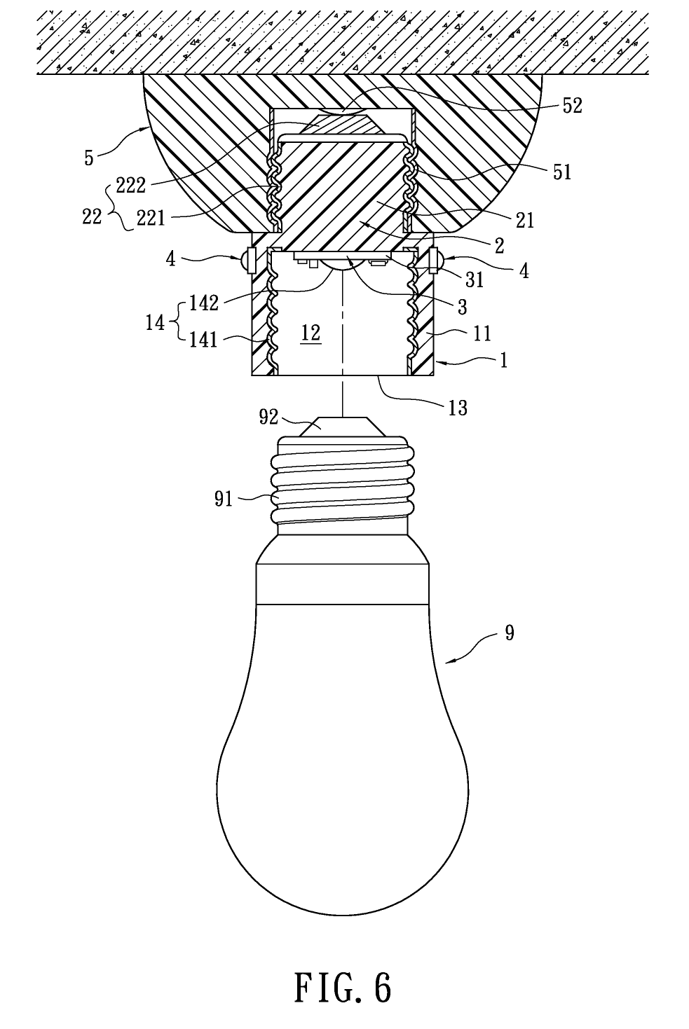

FIG. 6 shows another embodiment of the present disclosure. The adapter has a plurality of alarm indicators 4. The alarm indicators 4 are LEDs that are electrically connected to the control module 3. The alarm indicators 4 can be arranged randomly or orderly around the exterior of the female portion 1.

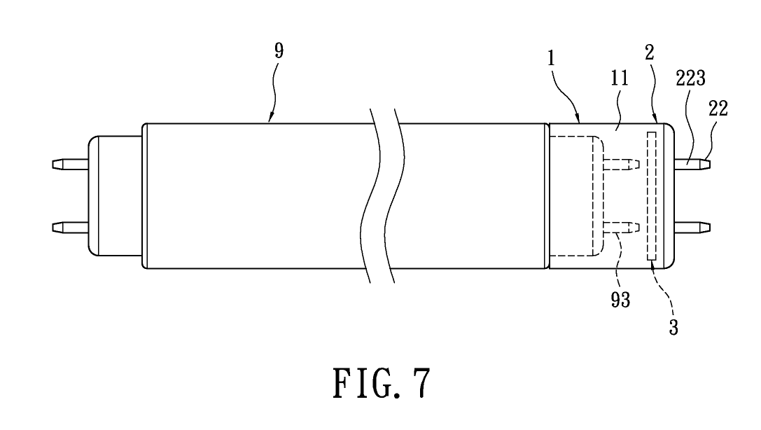

FIG. 7 shows yet another of the instant disclosure, which is applicable to the lamp tube type light source. The adapter includes a female portion 1, a male portion 2, and a control module (not shown). Both the female portion 1 and the male portion 2 are designed specifically for the lamp tube type light source 9 and the light socket (not shown). This embodiment is a variation from the embodiments shown in FIGS. 3 and 4. However, the female portion 1 of the present embodiment has a cylindrical body instead.

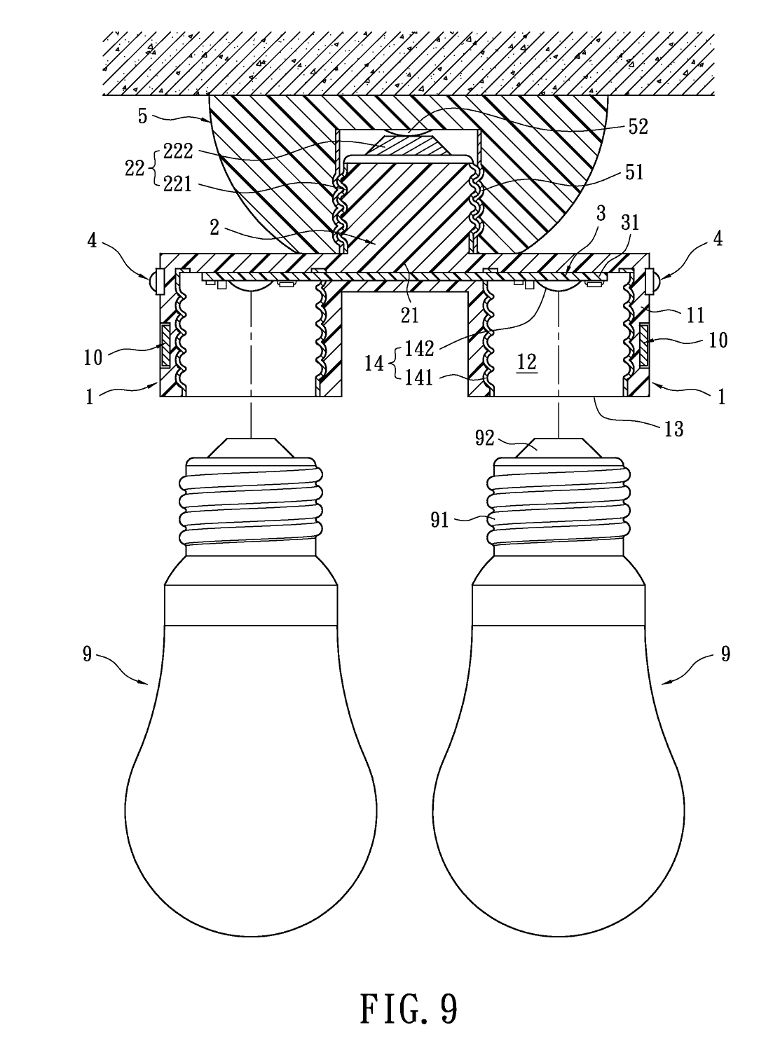

Moreover, the instant adaptor may comprise multiple female portions for housing multiple light generating devices. Referring to FIG. 9, which shows an embodiment of the instant adaptor having one male portion for establishing electrical connection with a power socket 5 and a plurality (in this case, two) of female portions 1 for connecting a plurality of light bulbs 9. Furthermore, the instant embodiment employs two control modules 3, each disposed in a female portion 1, respectively. However, person skill in the art should recognize that the number of the female portions 1 and the control modules 3 should not be limited to the illustration of the instant embodiment, but depends on the practical and operational requirements.

For the instant disclosure, the adapter and the light source are separate components. In other words, when the adapter's control module 3 or the light source 9 fails, each component can be replaced separately as needed in reducing repair cost and waste. In addition, the adapter, the light socket 5, and the light source 9 can be easily disconnected from one another with convenience.

Furthermore, the adapter of the instant disclosure can have an alarm indicator 4. When the control module 3, the light source 9, or the power supply fails, the alarm indicator 4 would illuminate or buzz. The alarm notifies the user to inspect the light assembly for malfunction.

Also, the control module 3 can convert regular power supply to LED type lighting application and controls light variation. Therefore, a regular light socket can be used along with a LED lamp tube.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A functional control adaptor for connecting a light generating device to a power socket, comprising:
a least one female portion having at least one inlet body, wherein the inlet body comprises a housing member having an opening and a first contact module for establishing electrical connection with the light generating device;
a male portion having an outlet body connecting to at least one inlet body, wherein the outlet body comprises a second contact module for establishing electrical connection with the power socket; and
at least one control module electrically connecting the first contact module of the female portion and the second contact module of the male portion.

2. The adapter according to claim 1, wherein the first contact module comprises a threaded collar and a contact strip, wherein the threaded collar is formed on the side wall of the housing member, wherein the contact strip is disposed on the bottom surface of the housing member, and wherein the control module is electrically connected to the threaded collar and the contact strip of the first contact module.

3. The adapter according to claim 1, wherein the second contact module comprises a threaded collar and a contact strip, wherein the threaded collar is disposed on the exterior of the outlet body, wherein the contact strip is disposed at the flat end of the outlet body; and wherein the control module is electrically connected to the threaded collar and contact strip of the second contact module.

4. The adapter according to claim 1, wherein the control module has a circuit board having electric circuits and chips thereon.

5. The adapter according to claim 1, wherein the first contact module has a plurality of electric sockets.

6. The adapter according to claim 1, wherein the second contact module has a plurality of electrodes.

7. The adapter according to claim 1, further comprising a replaceable battery electrically connecting the control module.

8. The adapter according to claim 1, further comprising at least one alarm indicator electrically connected to the control module, wherein the alarm indicator is a visual indicator or an audio indicator or a combination thereof.

9. The adapter according to claim 1, wherein the control module is disposed in the female portion of the adaptor.

10. The adapter according to claim 1, wherein the control module is disposed in the male portion of the adaptor.

11. A functional control adaptor for connecting a light generating device to a power socket, comprising:
at least one inlet portion having a first contact module;
an outlet portion having a second contact module connecting to at least one inlet portion; and
at least one control module electrically connecting to the first contact module of the inlet portion and the second contact module of the outlet portion.

12. The adapter according to claim 11, further comprising at least one alarm indicator electrically connecting the control module, wherein the alarm indicator is a visual indicator or an audio indicator or a combination thereof.

13. The adapter according to claim 11, further comprising a replaceable battery electrically connecting the control module.

14. The adapter according to claim 11, wherein the control module is disposed in the inlet portion of the adaptor.

15. The adapter according to claim 11, wherein the control module is disposed in the outlet portion of the adaptor.

16. A functional control adaptor for connecting a light generating device to a power socket, comprising:
a female portion having a first contact module; and
at least one control module disposed on the female portion, wherein the control module is electrically connected to the first contact module of the female portion.

17. The adapter according to claim 16, further comprising a replaceable battery electrically connecting the control module.

18. The adapter according to claim 16, further comprising at least one alarm indicator electrically connecting the control module, wherein the alarm indicator is a visual indicator or an audio indicator or a combination thereof.
